(19) United States
(12) Patent Application Publication
(10) Pub. No.: US 2004/0179795 A1
(43) Pub. Date: Sep. 16, 2004

(54) Optical fiber cable comprising a polymer-based insulative layer

(75) Inventors: Christian Cottevieille, Montreuil Sous Bois (FR); Gilles Laurec, Bonnelles (FR); Bernard Aladenize, Conflans-Ste-Honorine (FR)

Correspondence Address: SUGHRUE MION, PLLC, Suite 800, 2100 Pennsylvania Avenue, N.W., Washington, DC, 20037-3213, US

(73) Assignee: ALCATEL

(21) Appl. No.: 10/796,126

(22) Filed: Mar. 10, 2004

(30) Foreign Application Priority Data
Mar. 11, 2003 (FR) 03 02 965

(51) Int. Cl. G02B 6/44

(52) U.S. Cl. 385/103; 385/101

(57) ABSTRACT

An optical fiber cable comprises at least one central strength member, at least one optical fiber, a metallic conductor surrounding the fiber and, surrounding the conductor, a layer of an insulative composition comprising mainly a mixture of polymers comprising at least one high-density first polymer and one low-density second polymer which has a lower viscosity than the first polymer. It is preferable that the first polymer be high-density polyethylene and the second polymer be low-density polyethylene.

### CROSS-REFERENCE TO RELATED APPLICATIONS

This application is based on French Patent Application No. 03 02 965 filed March 11, 2003, the disclosure of which is hereby incorporated by reference thereto in its entirety, and the priority of which is hereby claimed under 35 U.S.C. §119.

### BACKGROUND OF THE INVENTION

1. Field of the Invention

The present invention relates to an optical fiber cable comprising a layer of a polymer-based composition. It relates in particular to a submarine cable usable for long-haul telecommunications. The invention further encompasses a method of fabricating the cable.

2. Description of the Prior Art

Submarine cables must function very reliably for at least 25 years in the hostile environment of the seabed, and this requires special cable design.

In a long-haul optical fiber telecommunication cable, the intensity of the light transported by the fiber is progressively attenuated and must therefore be amplified regularly (typically every 50 km). This amplification is effected by optical modules and necessitates the supply of electrical energy to power the laser diodes. In long-haul submarine telecommunication cables, electrical power is transported on the same cable and at the some lime as calls (remote power feed cables).

A cable of the above type comprises at least three main parts: an optical core comprising optical fibers and transporting information, a composite electrical conductor transporting the electrical energy necessary for powering the repeaters, and an insulator for separating the electrical conductor from the seawater. Diverse layers providing mechanical protection of the cable may be added around this structure, in accordance with the mechanical constraints to which the cable may be subjected. In cables laid in deep water, the mechanical stresses to which the cable is subjected are low and the insulation is in direct contact with the seawater, and in this case the insulation also provides mechanical protection of the cable against abrasion.

The insulation is routinely formed by extruding a high-density polyethylene layer around the conductor to protect the cable against abrasion and to insulate from the seawater the external metallic usually steel or copper, layer of the conductor.

Powering the repeaters necessitates the supply of sufficient electrical power. The power is proportional to the number of repeaters to be powered, i.e. to the number of fibers in the cable and to the length of the cable. If the necessary electrical power is high, either the current I or the voltage V may be increased. It is generally more advantageous to transport high power at a high voltage V and a low current I (to limit the section of the conductor, and thus the weight of the cable). In this case, the electrical stress (voltage gradient) applied to the insulation increases. Because of the high reliability required of this type of cable, it is therefore necessary to find insulators capable of safely supporting high voltage gradients.

The reliability of a cable using this kind of insulation depends on its working voltage and on the time for which that voltage is applied. In a long-haul optical fiber submarine telecommunication cable, the voltage is at a maximum and of opposite polarity at the two ends of the cable and zero at the mid-point. The decrease in the voltage from one end to the mid-point may be considered to be linear. A figure for the reliability of the whole of a cable, for example 5000 km of cable, is obtained by compounding the probability of survival for each unit length, for example each 0.5 km. For a submarine telecommunication cable, a service life of 25 years imposes a probability of failure by breakdown less than 10⁻¹².

The document WO-97/03 124 describes a jacket composition for a power or communication cable consisting of a mixture of polyolefins. In one particular embodiment, the mixture comprises at least a first polymer having a melt flow rate (MFR) from 0.1 g/10 min to 0.8 g/10 min and a density from 0.88 g/cm³ to 0.93 g/cm³, and a second polymer having an MFR from 50 g/10 min to 2000 g/10 min and a density from 0.93 g/cm³ to 0.975 g/cm³. The proportion of the second polymer is preferably at least 25% of the weight of the mixture.

The document EP-0 287 244 describes a submarine optical fiber cable for long-haul telecommunications having a layer of a composition comprising a medium density linear polyethylene that is a copolymer of ethylene and a C₄-C₁₀ α-olefin. The composition may further contain other additives used conventionally in insulators, such as a charge, a stabilizer or carbon block.

An object of the present invention is to eliminate the drawbacks of the prior art and in particular to propose an optical fiber cable whose resistance to breakdown is improved.

### SUMMARY OF THE INVENTION

The present invention consists in an optical fiber cable comprising at least one central strength member, at least one optical fiber, a metallic conductor surrounding the fiber and, surrounding the conductor, a layer of an insulative composition comprising mainly a mixture of polymers comprising at least one high-density first polymer and one low-density second polymer which has a lower viscosity than said first polymer.

According to a first aspect of the invention, the first polymer is a high-density, high-viscosity polymer. A high-density polymer means a polymer whose density is from 0.945 g/cm³ to 0.975 g/cm³ (cf. “Pratique des matériaux industriels”, published by DUNOD). A high-viscosity polymer means a polymer whose MFR measured in accordance with the ISO CD 1133 standard (with a load of 2.16 kg at 190° C.) is less than 6 g/10 min.

According to a first aspect of the invention, the second polymer is a low-density, low-viscosity polymer. A low-density polymer means a polymer whose density is from 0.915 g/cm³ to 0.945 g/cm³. (cf. “Pratique des matériaux industriels”, published by DUNOD). A low-viscosity polymer means a polymer whose MFR measured in accordance with the ISO CD 1133 standard is at least twice the MFR of the high-viscosity polymer.

In a first embodiment, the first polymer is a high-density polyethylene.

In a second embodiment, the second polymer is a low-density polyethylene.

In a third embodiment, the first polymer is a high-density polyethylene and the second polymer is a low-density polyethylene.

Polyethylene means linear or branched polyethylenes and copolymers of ethylene either with an α-olefin or with another monomer whose content does not exceed 15%.

The proportion of the second polymer is advantageously such that the influence on breakdown statistics of intrinsic defects of the second polymer remains negligible. The proportion of the second polymer is preferably at most 20% by weight of the mixture of polymers. This proportion is even more preferably from 5% to 20% by weight of the mixture of polymers.

The insulative composition according to the present invention may further comprise other additives used conventionally such as charges, stabilizers or lubricants, for example.

Other features and advantages of the present invention will become apparent on reading the following description of embodiments of the invention provided by way of illustrative and nonlimiting example, of course, and on examining the accompanying drawings.

### BRIEF DESCRIPTION OF THE DRAWINGS

FIG. 1 is a profile view of the two-screw extruder used to implement the present invention.

FIG. 2 is a section of a submarine telecommunication cable using the invention.

FIG. 3 is a diagrammatic representation of the probability of cumulative breakdown of two different insulative compositions as a function of the electric field.

FIG. 4 shows a cup-shaped test sample.

FIGS. 5 and 6 show the probability of cumulative breakdown as a function of the electric field for insulative compositions according to the invention compared to a reference insulative composition.

### DETAILED DESCRIPTION OF THE PREFERRED EMBODIMENT

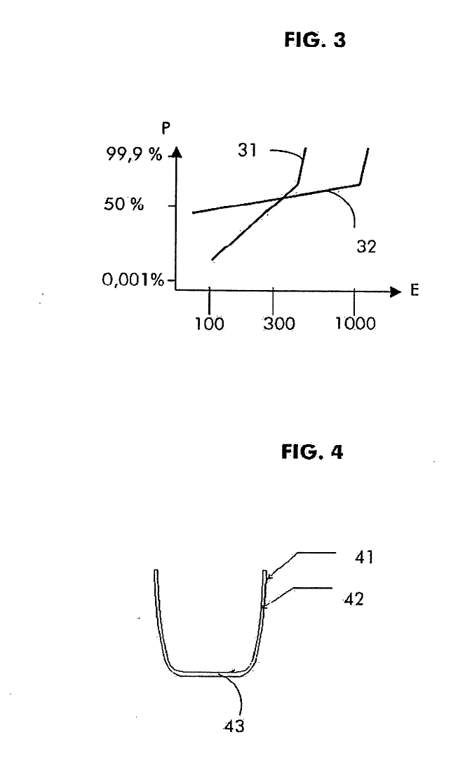

In FIGS. 3, 5 and 6 the percentage probability P of cumulative breakdown is plotted on the ordinate axis and the electric field E is plotted on a logarithmic scale on the abscissa axis; this is known as the Weibull representation.

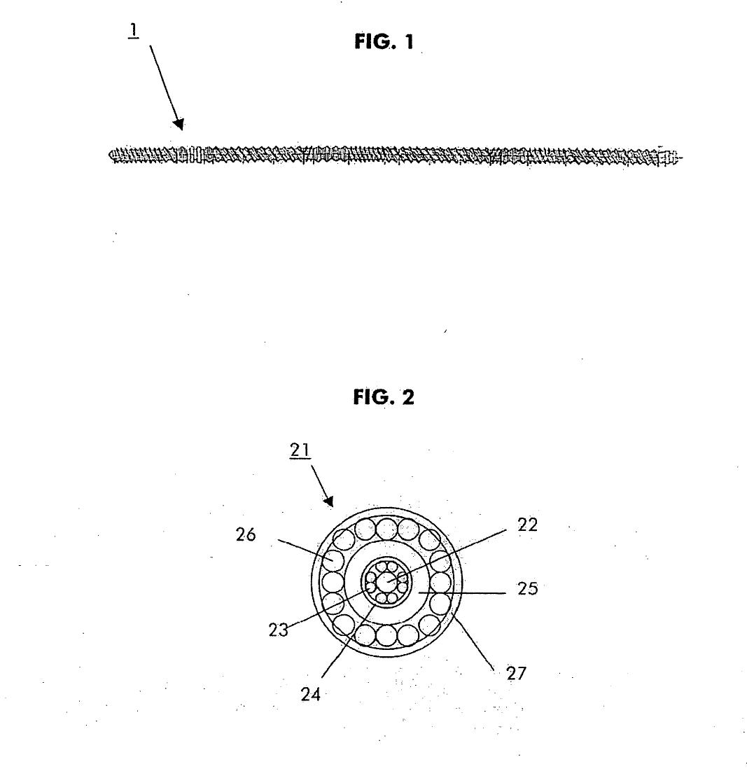

The mixture according to the invention is produced with a “Doctor Collins” two-screw extruder whose length L is approximately 25 times its diameter D, the extruder having in the present example a length L of 47.5 cm and a diameter D of 19 mm. The extruder 1 is shown in profile in FIG. 1. The rotation speed of the screw is from 100 rpm to 200 rpm. The temperature profile along the extruder 1 between the inlet and the outlet is as follows:

100° C./160° C./180° C./200° C./200° C./210° C./215° C./220° C.

The profile is shown from the inlet for the components of the mixture to the outlet for the mixture obtained, in the direction of forward movement of the mixture.

The mixture can also be produced using conventional techniques employing, for example, internal mixers, continuous mixers (Buss type), an extruder with a mixer screw, etc.

FIG. 2 shows in section a submarine cable 21 according to the invention. A central strength member 22 provides the mechanical strength of the optical core. Optical fibers 23 surround the member 22. The conductor consists of a steel or copper tube 24 and is surrounded by an insulative layer 25 constituting an internal sheath. Supplementary external layers such as an armor layer 2.6, consisting of galvanized steel wire, for example, and an external protection coating 27, for example of high-density polyethylene, may be added to improve the protection of the cable.

The insulative layer 25 that is the subject matter of the present invention comprises, for example, a mixture of 90% high-density polyethylene having an MFR of 0.05 g/10 min and 10% low-density polyethylene having an MFR of 22 g/10 min.

The probability of breakdown of an insulator depends on the intrinsic quality of the insulator (intrinsic breakdown probability) and on the probability of the presence of defects in the insulator and their harmful effect in relation to the electric field.

For example, FIG. 3 is a diagram showing the probability P of cumulative breakdown of two different insulative compositions as a function of the electrical field E. FIG. 3 uses the standard Weibull representation for this type of test. The electric field for a high probability of breakdown corresponds to the intrinsic quality of the insulative composition. For example, note in FIG. 3 that the intrinsic quality of the insulative composition represented by the curve 31 is superior to the intrinsic quality of the insulative composition represented by the curve 32. For low probabilities of breakdown, the slope of the curve of the breakdown probability P as a function of the electric field E corresponds to the presence of defects and to their harmful effect. Accordingly, in the FIG. 3 example, defects in the insulative composition represented by the curve 31 are more numerous and/or more harmful than defects in the insulative composition represented by the curve 32, since the slope is higher for the curve 32 than for the curve 31.

If the insulative layer is made from a high-viscosity polymer of high intrinsic quality, such as the high-density polyethylene used in the prior art, this layer features after forming numerous defects that trap space charges and cause an increase in the internal electric field. We have therefore studied the probability of breakdown of different insulators. These tests were not carried out on cables, but on cup-shaped laboratory samples as represented in FIG. 4 having an outside diameter 41 of 16 mm and an inside diameter 42 of 15.2 mm at the opening. These samples were produced on a press under white room conditions to limit the risk of pollution. This method produces large quantities of samples with a highly reproducible geometry in relatively short time periods. The electric voltage is applied between the exterior and the interior of the bottom of the cup, which has a Rogowski profile and a thickness 43 of 0.2 mm. A DC voltage ramp is applied at a rate of 2 kV/s until breakdown occurs. The breakdown probability is measured over series of 25 samples.

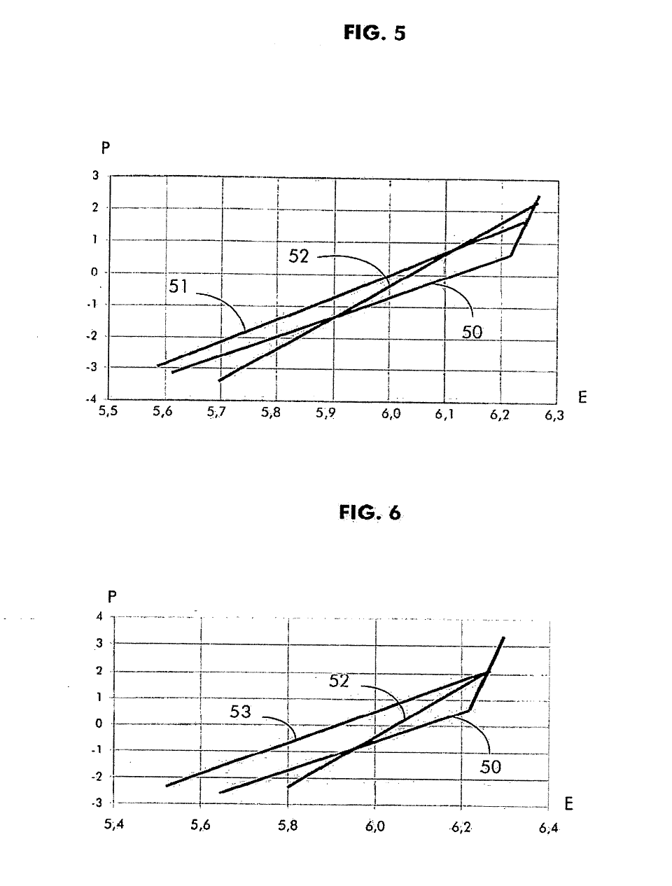

The breakdown probability curve 50 of the reference insulative composition currently used in the best submarine telecommunication cables is shown in FIG. 5 using the Weibull presentation. This polyethylene is the 47100 UV polyethylene from ATOFINA. It has an MFR of 0.05 g/10 min. The intrinsic breakdown field is of the order of exp(6.22)=500 kV/mm. The quantity and/or the harmful effects of the defects is characterized by the slope of the straight line. This slope, denoted [symbol] in Weibull analyses, here has the value [symbol] =5.6.

FIG. 4 compares the breakdown probability curve 50 of the reference insulation to the breakdown probability curves 51 and 52 of the same insulation respectively containing 5% and 10% of a much more fluid polyethylene having an MFR of 22 g/10 min. Note that the slope of the Weibull straight line increases, which means that the number and/or the harmfulness of the defects decreases. The intrinsic quality of the insulation appears to be improved by the addition of these quantities of fluid polyethylene. The slope [symbol] is 7.3 when 5% of fluid polymer is added and 9.3 when 10% of fluid polymer is added.

Note that the dielectric strength of the insulative layer according to the present invention is increased by 10% over a prior art insulative layer consisting only of high-density polyethylene. Moreover, the viscosity of the composition used is reduced by 5% relative to high-density polyethylene, which means that the cable can be extruded at a higher speed.

This result is of great benefit for the application to submarine telecommunication cables because in this application the operating electric field is low. Given the difference between the geometry of the cable and the test geometry, the equivalent field of the cable in operation is much less than 200 kV/mm, i.e. InE is much less than 5.4, and FIG. 4 shows that, in this area, the breakdown probability is lower for the mixture containing 10% fluid polymer.

FIG. 4 also shows that the addition of the fluid polymer slightly degrades the intrinsic dielectric strength of the reference polyethylene. This has no practical effect in this type of application because it occurs at electric fields that do not correspond to the working electric fields of the cable. It may be explained by the incorporation into the insulation system of defects in the fluid polymer.

FIG. 5 shows the breakdown probability curve 50 of the reference polyethylene compared to the breakdown probability curves 52 and 53 for the some polyethylene with 10% and 20% of fluid polymer added, respectively. Note that in this instance adding a large quantity of fluid polymer does not further improve the electrical properties of the mixture. This is explained by the contribution of defects in the fluid polymer to the breakdown phenomenon.

The explanation for the above results is as follows: the defects present in the reference polymer include in particular cavities with submicron dimensions. The critical size of the submicron cavities decreases as the applied electric field increases. Adding to the high-viscosity first polymer another polymer of lower viscosity, in accordance with the invention, fills in some of these microcavities. Reducing the number of defects in the layer in this way increases its dielectric strength and reduces the probability of failure. Of course, if the amount of polymer added is high, the dielectric quality of the polymer influences the dielectric quality of the mixture. If the dielectric quality of the fluid polymer is lower than that of the viscous polymer, above a certain content of fluid polymer the advantage obtained by eliminating microcavities is cancelled out by the reduced dielectric quality of the polymer. This critical content depends on the dielectric quality of the fluid polymer.

Of course, the above explanation is hypothetical, and the validity of the invention need not be called into question should the improvement noted result from some other physical mechanism.

There is claimed:

1. An optical fiber cable comprising at least one central strength member, at least one optical fiber, a metallic conductor surrounding said fiber and, surrounding said conductor, a layer of an insulative composition comprising mainly a mixture of polymers comprising at least one high-density first polymer and one low-density second polymer which has a lower viscosity than said first polymer.

2. The cable claimed in claim 1 wherein said first polymer has a melt flow rate less than 6 g/10 min.

3. The cable claimed in claim 1 wherein said first polymer is a high-density polyethylene and said second polymer is a low-density polyethylene.

4. The cable claimed in claim 1 wherein the proportion of said second polymer is at most 20% by weight of said polymer mixture.

5. The cable claimed in claim 4 wherein the portion of said second polymer is from 5% to 20% by weight of said polymer mixture.

6. The cable claimed in claim 1 wherein said insulative composition further contains additives.

7. A method of producing a cable as claimed in claim 1 wherein said first and second polymers are mixed by means of a two-screw extruder.

8. The method claimed in claim 7 wherein the length of said extruder is equal to approximately 25 times its diameter.

9. The method claimed in claim 7 wherein the rotation speed of said extruder is from 100 rpm to 200 rpm.

10. The method claimed in claim 7 wherein the temperature profile along said extruder between the inlet and the outlet is as follows:
100° C./160° C./180° C./200° C./200° C./210° C./215° C./220° C.
